(19) United States
(12) Patent Application Publication
(10) Pub. No.: US 2021/0314853 A1
(43) Pub. Date: Oct. 7, 2021

(54) SHARING SYSTEM INFORMATION AMONG MULTIPLE CELLS

(71) Applicant: QUALCOMM Incorporated, San Diego, CA (US)

(72) Inventors: Tianyang Bai, Somerville, NJ (US); Wooseok Nam, San Diego, CA (US); Sungwoo Park, Seoul (KR); Kiran Venugopal, Raritan, NJ (US); Tao Luo, San Diego, CA (US); Junyi Li, Franklin Park, NJ (US)

(21) Appl. No.: 17/224,044

(22) Filed: Apr. 6, 2021

Related U.S. Application Data
(60) Provisional application No. 63/006,636, filed on Apr. 7, 2020.

(51) Int. Cl. H04W 48/16; H04W 48/08; H04W 24/02

(52) U.S. Cl. CPC H04W 48/16; H04W 24/02; H04W 48/08

(57) ABSTRACT

Methods, systems, and devices for wireless communications are described. A base station may transmit a set of system information to a user equipment (UE), and the UE may identify an operation mode indicating that the system information is applicable for a plurality cells. When the UE detects that it is in a new cell associated with a second base station, the UE may apply the received system information to establish a communication channel in the new cell associated with the second base station. As such, rather than receiving and decoding new system information upon detection of a new cell/base station, the UE may be able to efficiently apply the known system information to establish a connection in the new cell.

### CROSS REFERENCE

The present application for Patent claims the benefit of U.S. Provisional Patent Application No. 63/006,636 by BAI et al., entitled “SHARING SYSTEM INFORMATION AMONG MULTIPLE CELLS,” filed Apr. 7, 2020, assigned to the assignee hereof, and expressly incorporated by reference herein.

### FIELD OF TECHNOLOGY

The following relates generally to wireless communications and more specifically to sharing system information among multiple cells.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

UEs may be deployed in high mobility environments. In such environments, UEs may dwell in a coverage area or cell of a base station for a short duration. The short dwell duration may make it difficult to acquire requisite information in order to establish a communication channel with a base station.

### SUMMARY

The described techniques relate to improved methods, systems, devices, and apparatuses that support sharing system information among multiple cells. Generally, the described techniques provide for a base station transmitting a set of system information to a user equipment (UE), and the UE may identify an operation mode indicating that the system information is applicable for a plurality cells. When the UE detects that it is in a new cell associated with a second base station, the UE may apply the received system information to establish a communication channel in the new cell associated with the second base station. As such, rather than receiving and decoding new system information upon detection of a new cell/base station, the UE may be able to efficiently apply the known system information to establish a connection in the new cell.

A method of wireless communications at a UE is described. The method may include receiving, from a first cell of a first base station, a first set of system information for the first cell, identifying an operation mode indicating that the first set of system information is applicable for a set cells, the set of cells including the first cell, receiving a signal indicating that the UE is in a second cell of a second base station, and communicating in the second cell according to the first set of system information based on the identified operation mode and the second cell being one of the set of cells.

An apparatus for wireless communications at a UE is described. The apparatus may include a processor, memory coupled with the processor, and instructions stored in the memory. The instructions may be executable by the processor to cause the apparatus to receive, from a first cell of a first base station, a first set of system information for the first cell, identify an operation mode indicating that the first set of system information is applicable for a set cells, the set of cells including the first cell, receive a signal indicating that the UE is in a second cell of a second base station, and communicate in the second cell according to the first set of system information based on the identified operation mode and the second cell being one of the set of cells.

Another apparatus for wireless communications at a UE is described. The apparatus may include means for receiving, from a first cell of a first base station, a first set of system information for the first cell, identifying an operation mode indicating that the first set of system information is applicable for a set cells, the set of cells including the first cell, receiving a signal indicating that the UE is in a second cell of a second base station, and communicating in the second cell according to the first set of system information based on the identified operation mode and the second cell being one of the set of cells.

A non-transitory computer-readable medium storing code for wireless communications at a UE is described. The code may include instructions executable by a processor to receive, from a first cell of a first base station, a first set of system information for the first cell, identify an operation mode indicating that the first set of system information is applicable for a set cells, the set of cells including the first cell, receive a signal indicating that the UE is in a second cell of a second base station, and communicate in the second cell according to the first set of system information based on the identified operation mode and the second cell being one of the set of cells.

In some examples of the method, apparatuses, and non-transitory computer-readable medium described herein, the first set of system information may be received in a master information block.

In some examples of the method, apparatuses, and non-transitory computer-readable medium described herein, the master information block includes an indication of a subcarrier spacing, a subcarrier offset, a demodulation reference signal position, a system information block location, a cell barred state, an intra-frequency selection state, or a combination thereof, and where communicating in the second cell according to the first set of system information includes applying, to the second cell, one or more of the subcarrier spacing, the subcarrier offset, the demodulation reference signal position, the system information block location, the cell barred state, or the intra-frequency selection state.

In some examples of the method, apparatuses, and non-transitory computer-readable medium described herein, the first set of system information may be received in a system information block.

In some examples of the method, apparatuses, and non-transitory computer-readable medium described herein, the system information block includes an indication of cell selection information, cell access information, connection establishment information, system information scheduling information, serving cell configuration information, emergency support information, timer information, barring information, extension information, or a combination thereof, and where communicating in the second cell according to the first set of system information includes applying, to the second cell, one or more of the cell selection information, the cell access information, the connection establishment information, the system information scheduling information, the serving cell configuration information, the emergency support information, the timer information, the barring information, or the extension information.

Some examples of the method, apparatuses, and non-transitory computer-readable medium described herein may further include operations, features, means, or instructions for receiving, from the first base station, a configuration message indicating the operation mode, where the operation mode may be identified based on the received configuration message.

Some examples of the method, apparatuses, and non-transitory computer-readable medium described herein may further include operations, features, means, or instructions for identifying the set of cells based on the configuration message.

In some examples of the method, apparatuses, and non-transitory computer-readable medium described herein, receiving the configuration message may include operations, features, means, or instructions for identifying the configuration message in a radio resource control message, a medium access control message, a physical downlink shared channel, or in a system information block.

Some examples of the method, apparatuses, and non-transitory computer-readable medium described herein may further include operations, features, means, or instructions for determining whether a master information block of the first set of system information may be shared between the set of cells based on the configuration message.

In some examples of the method, apparatuses, and non-transitory computer-readable medium described herein, the master information block may be shared between the set of cells based on a frequency range associated with the set of cells.

In some examples of the method, apparatuses, and non-transitory computer-readable medium described herein, the frequency range corresponds to a first frequency range usable by the UE and having frequencies lower than a second frequency range usable by the UE, where the master information block may be not shared between cells associated with the second frequency range.

Some examples of the method, apparatuses, and non-transitory computer-readable medium described herein may further include operations, features, means, or instructions for determining whether one or more system information blocks of the first set of system information may be shared between the set of cells based on the configuration message.

In some examples of the method, apparatuses, and non-transitory computer-readable medium described herein, the configuration message includes a physical cell identifier corresponding to each cell of the set of cells.

In some examples of the method, apparatuses, and non-transitory computer-readable medium described herein, the configuration message includes a table identifying the set of cells.

Some examples of the method, apparatuses, and non-transitory computer-readable medium described herein may further include operations, features, means, or instructions for identifying an area code in the signal indicating that the UE may be in the second cell, and determining that the second cell may be one of the set of cells based on the area code included in the first set of system information matching the area code included in the signal indicating that the UE may be in the second cell.

In some examples of the method, apparatuses, and non-transitory computer-readable medium described herein, the area code includes a routing area code or a tracking area code.

Some examples of the method, apparatuses, and non-transitory computer-readable medium described herein may further include operations, features, means, or instructions for receiving a configuration message identifying that the first set of system information may be shared between the set of cells based on the area code being shared between the set of cells.

Some examples of the method, apparatuses, and non-transitory computer-readable medium described herein may further include operations, features, means, or instructions for identifying a cell identifier in the signal indicating that the UE may be in the second cell, and determining that the second cell may be one of the set of cells based on the cell identifier.

Some examples of the method, apparatuses, and non-transitory computer-readable medium described herein may further include operations, features, means, or instructions for receiving, from one of the first base station and the second base station, a second set of system information that may be applicable to the set of cells based on the UE being in the operation mode.

Some examples of the method, apparatuses, and non-transitory computer-readable medium described herein may further include operations, features, means, or instructions for receiving, from one of the first base station and the second base station, a paging signal when the UE may be in an inactive or idle state, and transmitting, to the one of the first base station and the second base station, a random access request, where the second set of system information may be received in response to the random access request.

In some examples of the method, apparatuses, and non-transitory computer-readable medium described herein, communicating in the second cell may include operations, features, means, or instructions for communicating with the second base station without decoding at least a portion of system information received in the signal indicating that the UE may be in the second cell.

In some examples of the method, apparatuses, and non-transitory computer-readable medium described herein, communicating in the second cell may include operations, features, means, or instructions for identifying that the UE may be in an inactive state or an idle state, and performing a radio resource management procedure, a cell reselection procedure, or both, in the second cell using the first set of system information based on identifying that the UE may be in the inactive state or the idle state.

In some examples of the method, apparatuses, and non-transitory computer-readable medium described herein, receiving the signal indicating that the UE may be in the second cell may include operations, features, means, or instructions for identifying a synchronization signal block in a signal broadcast by the second base station, where the synchronization signal block includes information identifying the second cell.

A method of wireless communications at a base station is described. The method may include transmitting, to a UE, a first set of system information for a first cell of the base station, identifying an operation mode indicating that the first set of system information is applicable to communications in a set of cells including the first cell and at least one second cell associated with a second base station, and transmitting, to the UE, an indication of the identified operation mode.

An apparatus for wireless communications at a base station is described. The apparatus may include a processor, memory coupled with the processor, and instructions stored in the memory. The instructions may be executable by the processor to cause the apparatus to transmit, to a UE, a first set of system information for a first cell of the base station, identify an operation mode indicating that the first set of system information is applicable to communications in a set of cells including the first cell and at least one second cell associated with a second base station, and transmit, to the UE, an indication of the identified operation mode.

Another apparatus for wireless communications at a base station is described. The apparatus may include means for transmitting, to a UE, a first set of system information for a first cell of the base station, identifying an operation mode indicating that the first set of system information is applicable to communications in a set of cells including the first cell and at least one second cell associated with a second base station, and transmitting, to the UE, an indication of the identified operation mode.

A non-transitory computer-readable medium storing code for wireless communications at a base station is described. The code may include instructions executable by a processor to transmit, to a UE, a first set of system information for a first cell of the base station, identify an operation mode indicating that the first set of system information is applicable to communications in a set of cells including the first cell and at least one second cell associated with a second base station, and transmit, to the UE, an indication of the identified operation mode.

In some examples of the method, apparatuses, and non-transitory computer-readable medium described herein, the first set of system information may be transmitted in a master information block.

In some examples of the method, apparatuses, and non-transitory computer-readable medium described herein, the master information block includes an indication of a subcarrier spacing, a subcarrier offset, a demodulation reference signal position, a system information block location, a cell barred state, an intra-frequency selection state, or a combination thereof, and where one or more of the subcarrier spacing, the subcarrier offset, the demodulation reference signal position, the system information block location, the cell barred state, or the intra-frequency selection state may be applicable to the communications in the set of cells.

In some examples of the method, apparatuses, and non-transitory computer-readable medium described herein, the first set of system information may be transmitted in a system information block.

In some examples of the method, apparatuses, and non-transitory computer-readable medium described herein, the system information block includes an indication of cell selection information, cell access information, connection establishment information, system information scheduling information, serving cell configuration information, emergency support information, timer information, barring information, extension information, or a combination thereof, and where one or more of the cell selection information, the cell access information, the connection establishment information, the system information scheduling information, the serving cell configuration information, the emergency support information, the timer information, the barring information, or the extension information may be applicable to the communications in the set of cells.

In some examples of the method, apparatuses, and non-transitory computer-readable medium described herein, transmitting the indication of the operation mode may include operations, features, means, or instructions for transmitting a configuration message including the indication of the operation mode.

In some examples of the method, apparatuses, and non-transitory computer-readable medium described herein, the configuration message indicates the set of cells.

In some examples of the method, apparatuses, and non-transitory computer-readable medium described herein, transmitting the configuration message may include operations, features, means, or instructions for transmitting the configuration message in a radio resource control message, a medium access control message, a physical downlink shared channel, or in a system information block.

In some examples of the method, apparatuses, and non-transitory computer-readable medium described herein, the configuration message indicates whether a master information block of the first set of system information may be shared between the set of cells.

In some examples of the method, apparatuses, and non-transitory computer-readable medium described herein, the master information block may be shared between the set of cells based on a frequency range associated with the set of cells.

In some examples of the method, apparatuses, and non-transitory computer-readable medium described herein, the frequency range corresponds to a first frequency range usable by the UE and having frequencies lower than a second frequency range usable by the UE, where the master information block may be not shared between cells associated with the second frequency range.

In some examples of the method, apparatuses, and non-transitory computer-readable medium described herein, the configuration message indicates whether one or more system information blocks of the first set of system information may be shared between the set of cells.

In some examples of the method, apparatuses, and non-transitory computer-readable medium described herein, the configuration message includes a physical cell identifier corresponding to each cell of the set of cells.

In some examples of the method, apparatuses, and non-transitory computer-readable medium described herein, the configuration message includes a table identifying the set of cells.

In some examples of the method, apparatuses, and non-transitory computer-readable medium described herein, the configuration message indicates that the first set of system information may be shared between the set of cells based on an area code being shared between the set of cells.

In some examples of the method, apparatuses, and non-transitory computer-readable medium described herein, the area code includes a routing area code or a tracking area code.

Some examples of the method, apparatuses, and non-transitory computer-readable medium described herein may further include operations, features, means, or instructions for transmitting, to the UE, a second set of system information that may be applicable to the set of cells based on the UE being in the operation mode.

Some examples of the method, apparatuses, and non-transitory computer-readable medium described herein may further include operations, features, means, or instructions for transmitting, to the UE, a paging signal when the UE may be in an inactive state or an idle state, and receiving from the UE, a random access request, where the second set of system information may be transmitted to the UE in response to receiving the random access request.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure.

Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a system for wireless communications that supports sharing system information among multiple cells in accordance with aspects of the present disclosure.

FIG. 2 illustrates an example of a wireless communications system that supports sharing system information among multiple cells in accordance with aspects of the present disclosure.

FIG. 3 illustrates an example of a wireless communications system that supports sharing system information among multiple cells in accordance with aspects of the present disclosure.

FIG. 4 illustrates an example of a process flow diagram that supports sharing system information among multiple cells in accordance with aspects of the present disclosure.

FIGS. 5 and 6 show block diagrams of devices that support sharing system information among multiple cells in accordance with aspects of the present disclosure.

FIG. 7 shows a block diagram of a communications manager that supports sharing system information among multiple cells in accordance with aspects of the present disclosure.

FIG. 8 shows a diagram of a system including a device that supports sharing system information among multiple cells in accordance with aspects of the present disclosure.

FIGS. 9 and 10 show block diagrams of devices that support sharing system information among multiple cells in accordance with aspects of the present disclosure.

FIG. 11 shows a block diagram of a communications manager that supports sharing system information among multiple cells in accordance with aspects of the present disclosure.

FIG. 12 shows a diagram of a system including a device that supports sharing system information among multiple cells in accordance with aspects of the present disclosure.

FIGS. 13 and 14 show flowcharts illustrating methods that support sharing system information among multiple cells in accordance with aspects of the present disclosure.

### DETAILED DESCRIPTION

User equipments (UEs) may operate in high mobility environments, such as in trains, vehicles, etc. In new radio (NR) systems, base stations may be densely distributed in such environments to support enhanced wireless communication capabilities and to support communication over high bandwidths (e.g., millimeter wave (mmW) bandwidths). When UEs are operating in high mobility environments, the UEs may dwell in a coverage area or cell of a base station for a short duration. The short dwell duration may make it difficult to acquire requisite information in order to establish a communication channel with a base station. The requisite information may include various aspects of system information (SI), such as information included in a master information block (MIB) or a system information block (SIB).

The techniques described support a UE operation mode (e.g., a first UE operation mode) that supports sharing of system information among multiple cells and base stations, for example along a fixed path in which a UE may travel. A second UE operation mode may lack support for sharing system information among the multiple cells and base stations. One or both of the UE operation modes may include other parameter values, indicators, or configurations in addition to indicating support for the sharing of system information, for example that the system information is applicable for a plurality of cells. For example, UEs mobility may be predictable along the fixed path, such as a highway or a railway in a high speed train (HST) scenario. In such cases, the UE may travel with a predictable speed and/or in a predictable location relative to a set of base stations that are distributed along the path. A base station may transmit, to the UE, an identification of a plurality of cells that are supported by multiple base stations and a set of system information that may be used to communicate with each of the plurality of cells. When the UE detects that it is in a new cell, the UE may apply the received system information to establish a communication channel. As such, rather than receiving and decoding new system information upon detection of a new cell/base station, the UE may be able to efficiently apply the known system information to establish a connection. Aspects of the disclosure are described with respect to a fixed path, and more specifically a high speed train scenario, but it should be understood that the implementations may be applicable in other wireless communications system environments.

Particular aspects of the subject matter described herein may be implemented to realize one or more advantages. The described techniques may support improvements in a UE mobility framework and cell reselection procedure, decreasing signaling overhead, and improving reliability, among other advantages. As such, supported techniques may include improved network operations and, in some examples, may promote network efficiencies, among other benefits.

Aspects of the disclosure are initially described in the context of wireless communications systems. Aspects of the disclosure are further described with respect to an environment supporting sharing system information among multiple cells, a wireless communication system, and a process flow diagram supporting the techniques described herein. Aspects of the disclosure are further illustrated by and described with reference to apparatus diagrams, system diagrams, and flowcharts that relate to sharing system information among multiple cells.

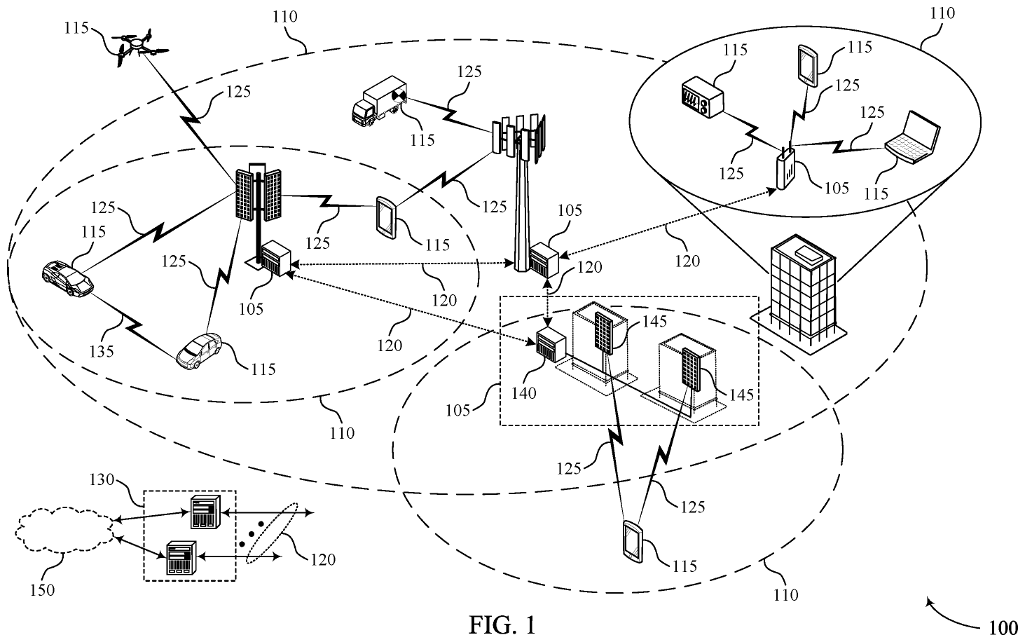

FIG. 1 illustrates an example of a wireless communications system 100 that supports sharing system information among multiple cells in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities, which may be referred to as radio heads, smart radio heads, or transmission/reception points (TRPs). Each access network transmission entity, for example a TRP 145, may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, base stations 105 may be distributed along a path in which UE 115 mobility is predictable. For example, a set of base station 105 may be distributed along a railway of a high speed train (HST) system. In such environments, UEs 115 may be devices of passengers within a train, or the UEs 115, or similar devices, such as repeaters or access nodes, may be integrated into the trains. When such UEs 115 operate in these high mobility environments, the dwell time of a UE 115 within a cell supported by one of the base stations 105 may be relatively short. Reception, decoding, and utilization of system information for a newly detected cell to establish a communication channel may increase overhead and delay as the UE 115 travels along the predicable trajectory with high speed.

To resolve these issues, the techniques described herein provide for sharing of system information among a plurality of cells in accordance with an operating mode. The operating mode may be referred to a homogenous mode or a high speed train mode, and since cell/synchronization signal block (SSB) deployment is regular (e.g., the base stations are regularly positioned near the track or path), neighboring cells may have the same configuration in terms of SSB arrangement, cell reselection configuration, etc. Accordingly, the cells may share the system information. The UE 115 may receive a set of system information from a first cell associated with a first base station 105. The UE 115 may identify the operation mode indicating that the received set of system information is applicable to plurality of cells including the first cell. The operation mode may be identified based on some indication received in the system information, a configuration message, etc. In some cases, a configuration message may include a listing or table of cells (e.g., physical cell identifiers (PCIDs)) that share the system information. In other cases, the cells share an area code such as tracking area code (TAC) or routing area code (RAC). When the UE 115 identifies that it is operating in a new cell, the UE may determine whether the new cell is one of the plurality of cell indicated (or whether it shares the same area code) and apply the system information to a communication channel. Accordingly, the UE 115 may not need to receive, decode, and apply new system information corresponding to the new cell, thus reducing overhead at the UE 115.

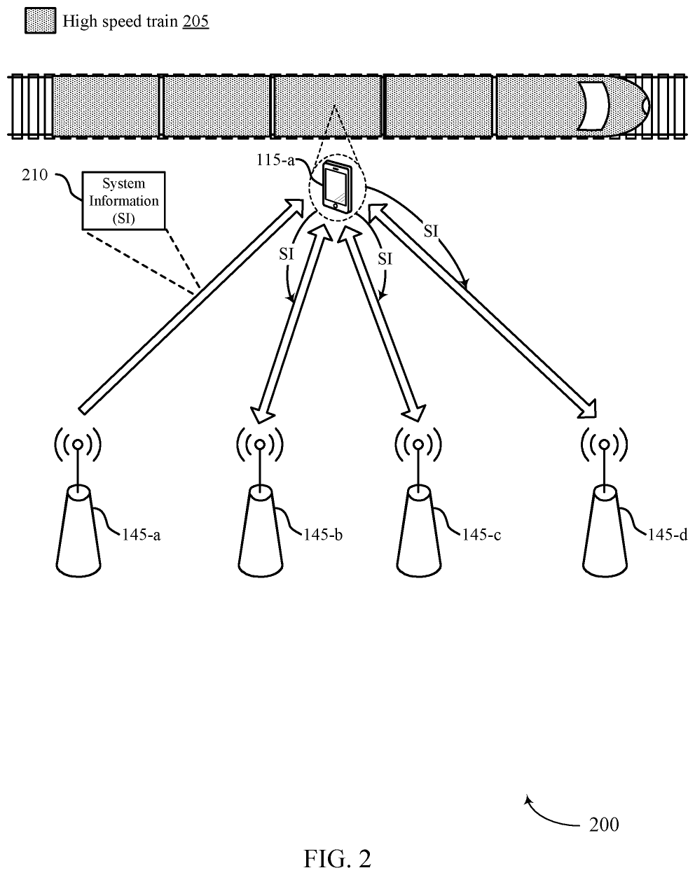

FIG. 2 illustrates an example of a wireless communications system 200 that supports sharing system information among multiple cells in accordance with aspects of the present disclosure. In some examples, wireless communications system 200 may implement aspects of wireless communications system 100. The wireless communications system 200 includes TRPs 145-a, 145-b, 145-c, and 145-d, which may be examples of a base station 105 or TRPs 145 of FIG. 1. More particularly, in some examples implementations, the TRPs 145 may be referred to as base stations 105. The wireless communications system 200 also includes UE 115-a, which may be an example of a UE 115 as described with reference to FIG. 1. The wireless communications system 200 may also include an HST 205, which may carry any number of UEs 115. TRPs 145-a, 145-b, 145-c, and 145-d may serve the same geographic coverage area, or different geographic coverage areas. The TRPs 145 may positioned along the train track in a manner to provide a continuous or near continuous coverage are for UEs 115 of the HST 205. In some cases, the positioning may depend on the operating frequency. For example, the TRP 145 positionings for frequency 1 (FR1) or 4 GHz communications and the positionings for TRP 145 positionings for frequency 2 (FR2) or 30 GHz communications may be different. Further the configurations may be different for the different frequencies. FR1 may operate in a macro-only or macro+relay (FR1 for base station-to-relay) configuration, and FR1 may operate in macro+relay (FR2/4 for base station-to-relay) configuration. These different layouts/configurations may determine a reference cell layout.

For UE 115-a to establish a connection with a cell of one of the TRPs 145 (base stations), the UE 115-a may acquire system information 210. In some cases, system information 210 is received in a MIB and/or a set of SIBs, which may include SIB 1 through SIB 9 (SIB1-9). The UE 115-a may use information from the MIB, one or more SIBs, or a combination thereof, to establish a communication channel with a cell of a TRP 145. General system information provides information for the UE 115 to access the network, such as cell selection information, paging, etc. The MIB may be broadcast by the base stations 105 (e.g., TRPs 145) in a physical broadcast channel (PBCH) of an SSB, and the SIBs may be transmitted in a physical downlink shared channel (PDSCH). The MIB may provide configuration information such that the UE 115-a may identify the SIB1 in the PDSCH. The SIB1 may be referred to as remaining system information (RMSI), and the SIB1 may provide scheduling information for SIB2-9, which may be referred to as other system information (OSI). Some of the OSI may not be broadcast, and the UE 115-a may request the SIB2-9 on demand using MSG1 or MSG3 in a random access channel (RACH) procedure. For example, the UE 115-a may use a dedicated preamble in MSG1 of RACH to request SI, or the UE 115-a may use contention based random access (CBRA) RACH and indicate the purpose in MSG4.

A MIB may include system information such as a system frame number, a subcarrier spacing, an SSB subcarrier offset, a demodulation reference signal (DMRS) position, a physical downlink control channel (PDCCH) configuration for SIB1 (e.g., SIB1 location), a cell barred status (e.g., a status indicating whether the cell is barred, and may not be camped on by a UE, or not, and the cell may be camped on by the UE), an intra-frequency reselection status (e.g., indicating whether intra-frequency reselection is allowed or disallowed), etc. SIB1 may include system information such as, cell selection information, cell access information, connection establishment information, system information scheduling information, serving cell configuration information, emergency support information, call over IMS support information, timer and constant information, barring information, resume identifiers, non-critical extensions, critical extensions, etc. The UE 115-a may use at least a portion of such information from the MIB or the SIB1 to communicate in a cell (e.g., by applying the system information).

In some cases, as the UE 115-a travels along the tracks in the HST 205, the UE 115-a may acquire system information for a cell corresponding to each TRP 145 (e.g., system information 210 for a cell corresponding to TRP 145-a). As the train may be traveling at a high rate, acquisition and application of system information for each TRP 145 may incur overhead. To reduce such overhead, according to the techniques described herein, a plurality of cells corresponding to the TRPs 145 may share the system information 210. As such, the UE 115-a may apply at least a portion of the shared system information 210 to each identified cell for communications, which may reduce the overhead of system information acquisition and application. To support the shared system information 210, the UE 115-a identify an operation mode that indicates that the system information 210 is shared between the plurality of cells. The UE 115-a may identify the operation mode in accordance with a configuration message received from a base station 105 or one of the TRPs 145. For example, a first TRP 145-a (in a path of travel by the HST 205) of the set of TRPs 145 may transmit a configuration message indicating the operating mode, a plurality of cell identifiers, or both corresponding to the shared system information 210. As such, the TRP 145-a may transmit the configuration message as well as the system information 210. In some cases, the system information 210 may include the configuration message that indicates the operating mode, the cell identifiers, or both.

As illustrated in FIG. 2, the UE 115-a receives the system information 210 and applies the system information 210 to communications with TRPs 145-b, 145-c, and 145-d. In some examples, the UE 115-a may detect that it is in a new cell corresponding to a TRP 145, such as TRP 145-b, as the UE 115-a travels with the HST 205. To detect a new cell, the UE 115-a may receive an SSB broadcast in the cell associated with TRP 145-b, identify a cell identifier (e.g., PCID), and determine that the cell ID is one of the plurality cell IDs that is indicated as sharing the system information 210. In response to determining that cell ID corresponds to one of the cells indicated as sharing system information, the UE 115-a may apply at least a portion of the system information 210 to communications in the cell corresponding to TRP 145-b. In some examples, the UE 115-a identifies that the cell corresponding to TRP 145-b shares the system information 210 based on the cell having the same area code (e.g., tracking area code (TAC) or routing area code (RAC)). That is, the cell associated with TRP 145-a and the cell associated with TRP 145-b may share the area code. In response to detecting the shared area code, the UE 115-a may apply at least a portion of the system information 210 to the communications in the cell associated with TRP 145-b. The area code may also be shared by each cell associated with TRP 145-c and 145-d.

In applying the system information 210 to the communications in the various cells, the UE may communicate with the other base stations or TRPs 145 without decoding some or all of the system information of the cell, which may reduce overhead. Further, when the UE 115-a is in an active or idle state, the UE 115-a may perform a radio resource management (RRM) procedure, a cell reselection procedure, or both using the system information 210 in a new cell.

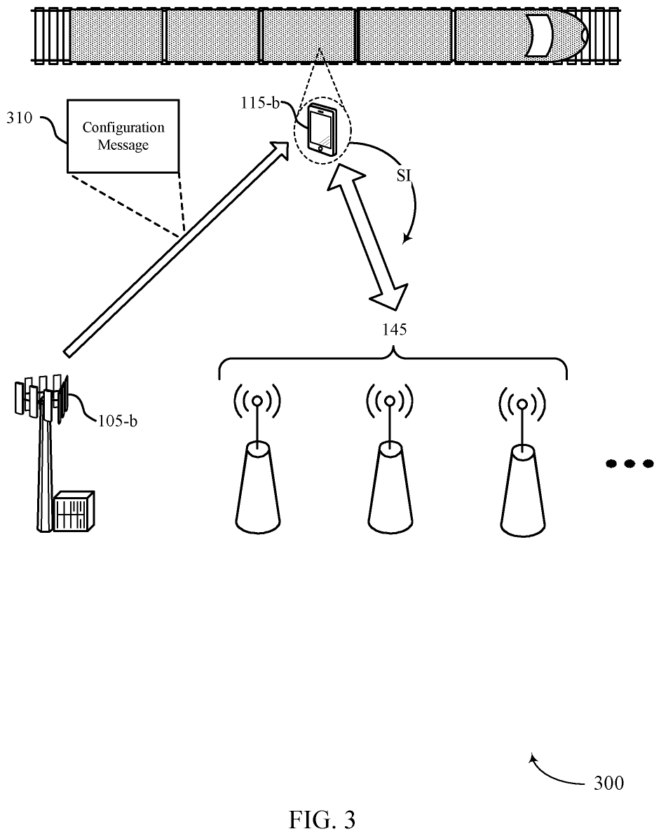

FIG. 3 illustrates an example of a wireless communications system 300 that supports sharing system information among multiple cells in accordance with aspects of the present disclosure. In some examples, wireless communications system 300 may implement aspects of wireless communications system 100. The wireless communications system 200 includes a base station 105-b, a UE 115-b, and TRPs 145, which may be examples of a base station 105 or TRPs 145 of FIGS. 1 and 2. More particularly, in some examples implementations, the TRPs 145 may be referred to as base stations 105. The wireless communications system 200 may also include an HST 205, which may carry any number of UEs 115. TRPs 145 may serve the same geographic coverage area, or different geographic coverage areas. The TRPs 145 may positioned along the train track in a manner to provide a continuous or near continuous coverage are for UEs 115 of the HST 205.

UEs 115 on the HST 205 travel along the tracks of the HST 205, and thus the UE 115-b mobility and trajectory may be predictable. Accordingly, cells associated with various base stations or TRPs 145 may be configured to provide services in a predictable manner. That is, neighboring cell associated with the neighboring base stations 105 or TRPs 145 may have the same configuration in terms of SSB arrangement and cell reselection configuration. Thus, these cells may share the same system information along the railway. When the UE 115-b enters a geographic area that includes base stations 105 that may share the system information, a base station 105 or TRP 145 may transmit the system information as well as an indication of the cells that share the system information. As illustrated in FIG. 3, the base station 105-b transmits a configuration message 310 to the UE 115-b.

The configuration message 310 may include an indication of the operating mode that configures the UE 115-b to apply the shared system information to the other cells. The configuration message 310 may include an indication of the cell identifiers, which may be in the form of a table of cell identifiers. In some cases, the UE 115-b determines that it is operating in the system information sharing operating mode based on receiving the plurality of cell identifiers. Accordingly, when the UE 115-b detects a signal that the UE 115-b is operating in a new cell, the UE 115-b may determine whether the new cell has a cell identifier that is indicated in the configuration message. Based on the determination, the UE 115-b may apply the system information to the new cell associated with TRP 145.

In some examples, the configuration message 310 may indicate that the cells that share the system information share an area code, such as a tracking area code or routing area code. Thus, when the UE 115-b is operating in a new cell, the UE 115-b may determine whether the area code of the new cell is shared by the previous (or a previous) cell. Based on the determination, the UE 115-b may apply the system information to the new cell associated with a base station 105 (or TRP 145).

The configuration message 310 may indicate which portions of the system information that may be shared. For example, the configuration message 310 may indicate that some of the system information of the MIB is the shared system information. In other cases, the configuration message 310 may indicate that some of the information of the SIB1 is shared system information. The configuration message 310 may also indicate that information of both the MIB and the SIB is shared system information. In some cases, the ability to share system information may be limited based on the frequency range. For example, in FR1, the system information of a MIB may be shared between cells. However, in FR2, the MIB may include information bits containing indices of SSBs, and the UE may decode the PBCH to retrieve such SSB ID information. In such cases, the MIB information may not be shareable between cells.

In some cases, the configuration message 310 is transmitted using RRC signaling, a medium access control-control element (MAC-CE) message, a PDSCH, or a SIB. Thus, the UE 115-b may receive and decode an SSB from base station 105-b and identify the MIB and the SIB1. The SIB1 may contain the information indicating the operating mode, the cells that share the system information, the indication of the system information that is shared (e.g., information of the MIB), or a combination thereof. As such, the general system information (e.g., the MIB and SIB) may contain the indication of the shared system information (e.g., the operating mode) as well as the set of information that is shared (e.g., the set of system information that is applicable to other cells).

The base station 105-b or the TRPs 145 may also update the set of shared system information by transmitting an indication of the new system information. When the UE 115-b is in an inactive or idle state, the base station 105-b may transmit a paging signal. In response to the paging signal, the UE 115-b may transmit a random access request (e.g., as a part of a RACH procedure). In response to receiving the random access request, the base station 105-b may transmit the second or updated set of system information to the UE 115-b. The UE 115-b may apply the second or updated set of system information based on the UE being in the operating mode.

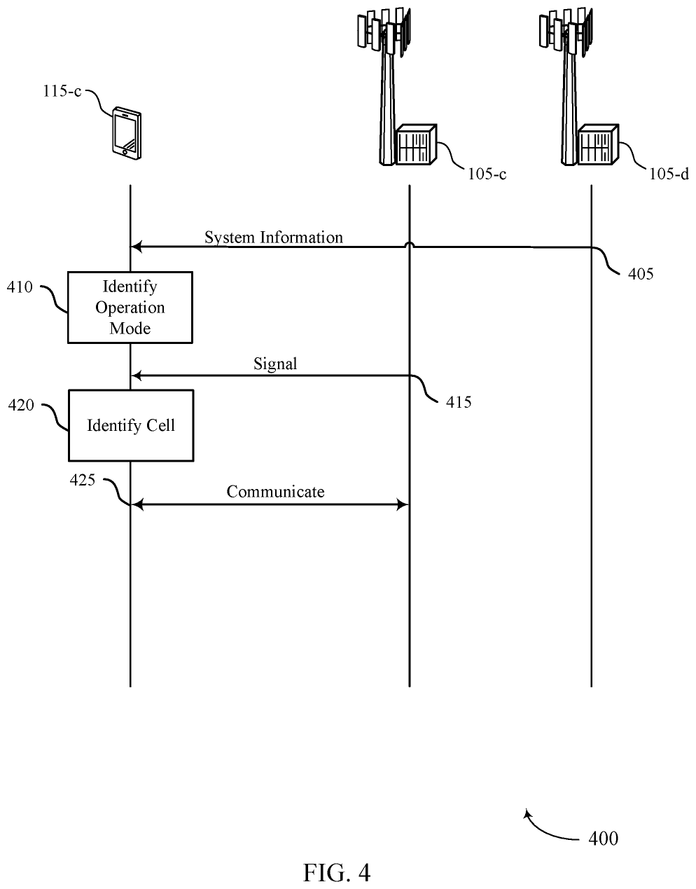

FIG. 4 illustrates an example of a process flow diagram 400 that supports sharing system information among multiple cells in accordance with aspects of the present disclosure. In some examples, the process flow diagram 400 may implement aspects of wireless communications system 100. The process flow diagram 400 includes a UE 115-c and base stations 105-c and 105-d, which may be examples of the corresponding devices of FIGS. 1 through 3. In some cases, the base stations 105-c and 105-d may be examples of TRPs 145 as described in FIGS. 1 through 3.

At 405, the UE 115-c may receive, from a cell of the base station 105-d, a first set of system information for the first cell. The first set of system information may be included in a MIB, a SIB, or a combination thereof.

At 410, the UE 115-c may identify an operation mode indicating that the first set of system information is applicable for a plurality cells. The plurality of cells may include the first cell. In some cases, the operation mode may be identified based on a configuration message that includes an identification of the operation mode, the plurality of cells, a configuration for a shared area code for the plurality of cells, etc. The configuration message may be transmitted using RRC signaling, system information (e.g., in SIB1), a PDSCH, etc. In some examples, the configuration message indicates which system information is shared (e.g., at least a portion of the MIB, at least a portion of the SIB1, or both).

At 415, the UE 115-c may receive a signal indicating that the UE is in a second cell of the second base station 105-c. In some examples, the signal may be an SSB broadcast in the second cell of the second base station 105-c.

At 420, the UE 115-c may identify the second cell. In some cases, the UE 115-c may detect a PCID based on the SSB to identify the second cell. In some examples, the UE 115-c detects an area code (e.g., tracking area code or routing area code) of the second cell. The UE 115-c may identify that the second cell is one of the plurality of cells in which the first set of system information is applicable.

At 425, the UE 115-c may communicate in the second cell of the second base station 105-c according to the first set of system information based at least in part on the identified operation mode and the second cell being one of the plurality of cells. Communicating may include applying the first set of system information without decoding a portion of system information received in the second cell. Communicating may also include performing an RRM procedure, a cell reselection procedure, or both.

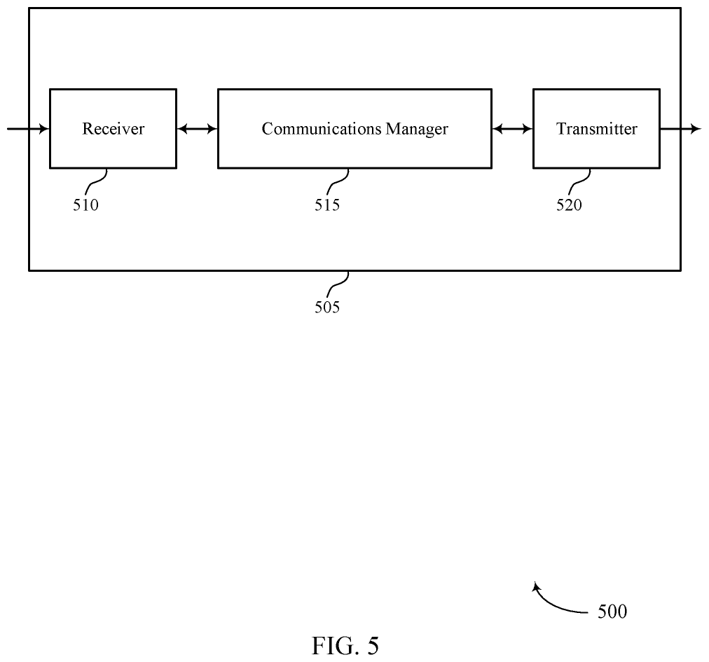

FIG. 5 shows a block diagram 500 of a device 505 that supports sharing system information among multiple cells in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

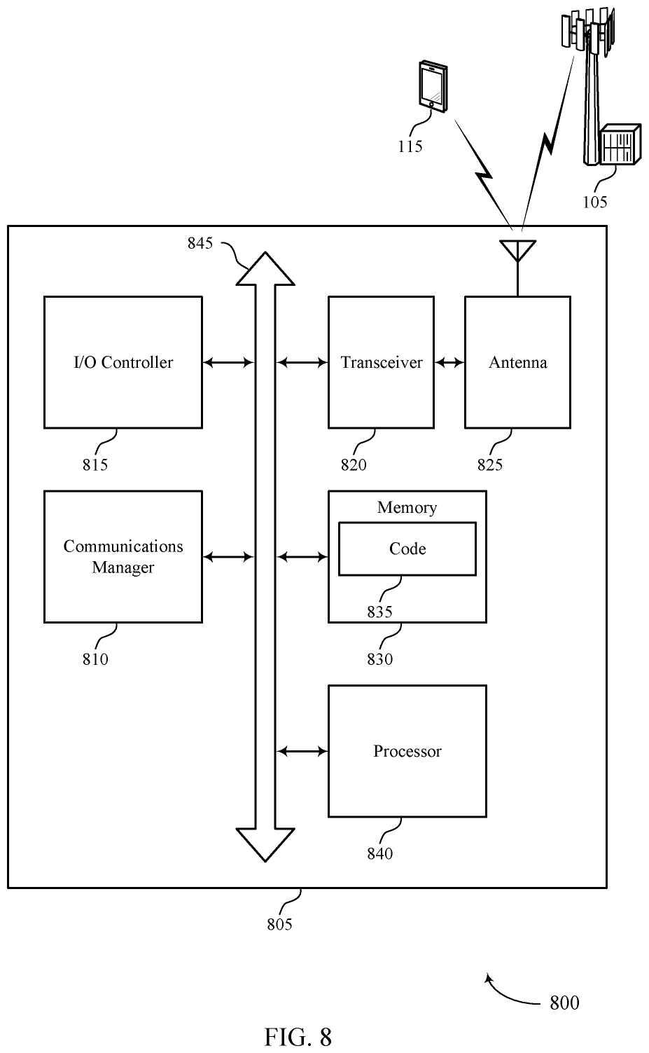

The receiver 510 may receive information such as packets, user data, or control information associated with various information channels (e.g., control channels, data channels, and information related to sharing system information among multiple cells, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may receive, from a first cell of a first base station, a first set of system information for the first cell, identify an operation mode indicating that the first set of system information is applicable for a set cells, the set of cells including the first cell, receive a signal indicating that the UE is in a second cell of a second base station, and communicate in the second cell according to the first set of system information based on the identified operation mode and the second cell being one of the set of cells. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

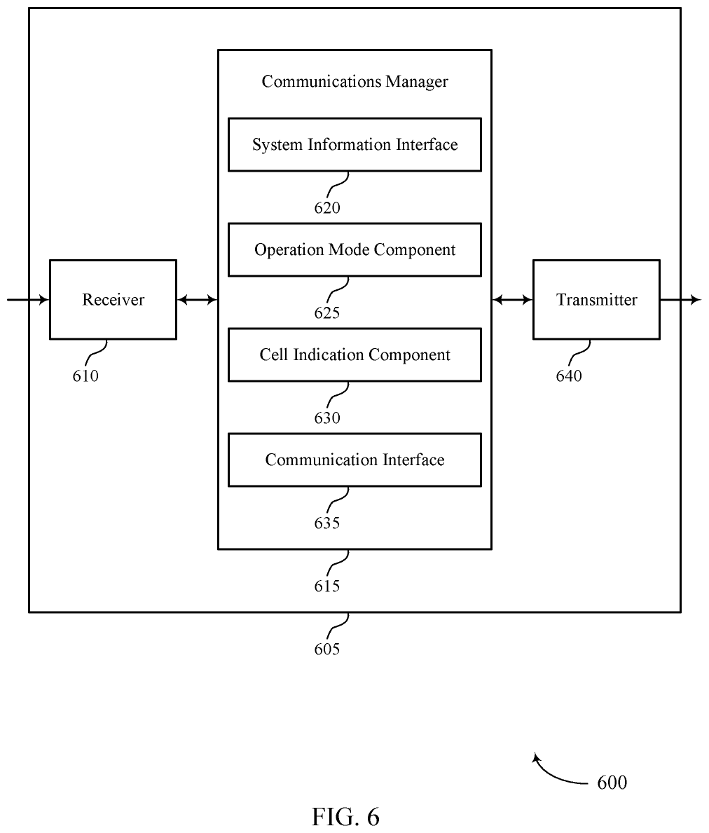

FIG. 6 shows a block diagram 600 of a device 605 that supports sharing system information among multiple cells in accordance with aspects of the present disclosure. The device 605 may be an example of aspects of a device 505, or a UE 115 as described herein.

The device 605 may include a receiver 610, a communications manager 615, and a transmitter 640. The device 605 may also include a processor. Each of these components may be in communication with one another (e.g., via one or more buses).

The receiver 610 may receive information such as packets, user data, or control information associated with various information channels (e.g., control channels, data channels, and information related to sharing system information among multiple cells, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a system information interface 620, an operation mode component 625, a cell indication component 630, and a communication interface 635. The communications manager 615 may be an example of aspects of the communications manager 810 described herein.

The system information interface 620 may receive, from a first cell of a first base station, a first set of system information for the first cell.

The operation mode component 625 may identify an operation mode indicating that the first set of system information is applicable for a set cells, the set of cells including the first cell. The cell indication component 630 may receive a signal indicating that the UE is in a second cell of a second base station.

The communication interface 635 may communicate in the second cell according to the first set of system information based on the identified operation mode and the second cell being one of the set of cells.

The transmitter 640 may transmit signals generated by other components of the device 605. In some examples, the transmitter 640 may be collocated with a receiver 610 in a transceiver module. For example, the transmitter 640 may be an example of aspects of the transceiver 820 described with reference to FIG. 8. The transmitter 640 may utilize a single antenna or a set of antennas.

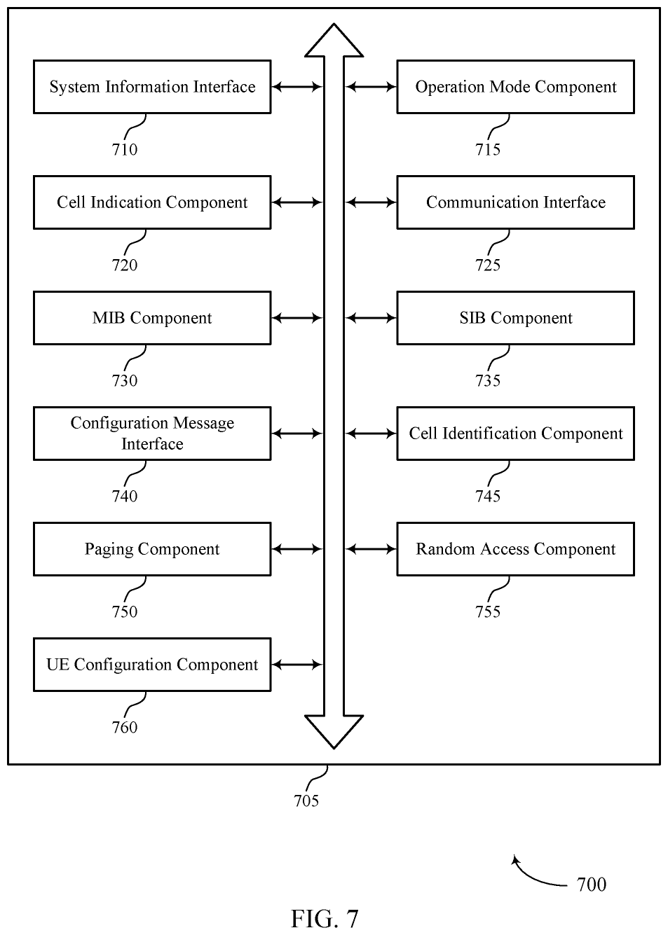

FIG. 7 shows a block diagram 700 of a communications manager 705 that supports sharing system information among multiple cells in accordance with aspects of the present disclosure. The communications manager 705 may be an example of aspects of a communications manager 515, a communications manager 615, or a communications manager 810 described herein. The communications manager 705 may include a system information interface 710, an operation mode component 715, a cell indication component 720, a communication interface 725, a MIB component 730, a SIB component 735, a configuration message interface 740, a cell identification component 745, a paging component 750, a random access component 755, and a UE configuration component 760. Each of these modules may communicate, directly or indirectly, with one another (e.g., via one or more buses).

The system information interface 710 may receive, from a first cell of a first base station, a first set of system information for the first cell.

In some examples, the system information interface 710 may receive, from one of the first base station and the second base station, a second set of system information that is applicable to the set of cells based on the UE being in the operation mode.

In some cases, the first set of system information is received in a master information block. In some cases, the first set of system information is received in a system information block.

The operation mode component 715 may identify an operation mode indicating that the first set of system information is applicable for a set cells, the set of cells including the first cell.

In some examples, the operation mode component 715 may determine whether a master information block of the first set of system information is shared between the set of cells based on the configuration message.

In some examples, the operation mode component 715 may determine whether one or more system information blocks of the first set of system information is shared between the set of cells based on the configuration message. In some examples, the operation mode component 715 may determine that the second cell is one of the set of cells based on the cell identifier.

In some cases, the configuration message includes a physical cell identifier corresponding to each cell of the set of cells. In some cases, the configuration message includes a table identifying the set of cells.

The cell indication component 720 may receive a signal indicating that the UE is in a second cell of a second base station.

In some examples, identifying a synchronization signal block in a signal broadcast by the second base station, where the synchronization signal block includes information identifying the second cell.

The communication interface 725 may communicate in the second cell according to the first set of system information based on the identified operation mode and the second cell being one of the set of cells.

In some examples, the communication interface 725 may communicate with the second base station without decoding at least a portion of system information received in the signal indicating that the UE is in the second cell.

In some examples, the communication interface 725 may perform a radio resource management procedure, a cell reselection procedure, or both, in the second cell using the first set of system information based on identifying that the UE is in the inactive state or the idle state.

The MIB component 730 may identify the first set of system information in the MIB. In some cases, the master information block includes an indication of a subcarrier spacing, a subcarrier offset, a demodulation reference signal position, a system information block location, a cell barred state, an intra-frequency selection state, or a combination thereof, and where communicating in the second cell according to the first set of system information includes applying, to the second cell, one or more of the subcarrier spacing, the subcarrier offset, the demodulation reference signal position, the system information block location, the cell barred state, or the intra-frequency selection state.

In some cases, the master information block is shared between the set of cells based on a frequency range associated with the set of cells. In some cases, the frequency range corresponds to a first frequency range usable by the UE and having frequencies lower than a second frequency range usable by the UE, where the master information block is not shared between cells associated with the second frequency range.

The SIB component 735 may identify a cell identifier in the signal indicating that the UE is in the second cell. In some cases, the SIB component 736 may identify the first set of system information in a system information block.

In some cases, the system information block includes an indication of cell selection information, cell access information, connection establishment information, system information scheduling information, serving cell configuration information, emergency support information, timer information, barring information, extension information, or a combination thereof, and where communicating in the second cell according to the first set of system information includes applying, to the second cell, one or more of the cell selection information, the cell access information, the connection establishment information, the system information scheduling information, the serving cell configuration information, the emergency support information, the timer information, the barring information, or the extension information.

The configuration message interface 740 may receive, from the first base station, a configuration message indicating the operation mode, where the operation mode is identified based on the received configuration message.

In some examples, the configuration message interface 740 may identify the configuration message in a radio resource control message, a medium access control message, a physical downlink shared channel, or in a system information block.

In some examples, the configuration message interface 740 may receive a configuration message identifying that the first set of system information is shared between the set of cells based on the area code being shared between the set of cells.

The cell identification component 745 may identify the set of cells based on the configuration message. In some examples, the cell identification component 745 may identify an area code in the signal indicating that the UE is in the second cell.

In some examples, the cell identification component 745 may determine that the second cell is one of the set of cells based on the area code included in the first set of system information matching the area code included in the signal indicating that the UE is in the second cell. In some cases, the area code includes a routing area code or a tracking area code.

The paging component 750 may receive, from one of the first base station and the second base station, a paging signal when the UE is in an inactive or idle state.

The random access component 755 may transmit, to the one of the first base station and the second base station, a random access request, where the second set of system information is received in response to the random access request. The UE configuration component 760 may identify that the UE is in an inactive state or an idle state.

FIG. 8 shows a diagram of a system 800 including a device 805 that supports sharing system information among multiple cells in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may receive, from a first cell of a first base station, a first set of system information for the first cell, identify an operation mode indicating that the first set of system information is applicable for a set cells, the set of cells including the first cell, receive a signal indicating that the UE is in a second cell of a second base station, and communicate in the second cell according to the first set of system information based on the identified operation mode and the second cell being one of the set of cells.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include RAM and ROM. The memory 830 may store computer-readable, computer-executable code 835 including instructions that, when executed, cause the processor to perform various functions described herein. In some cases, the memory 830 may contain, among other things, a basic input/output system (BIOS) which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting sharing system information among multiple cells).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

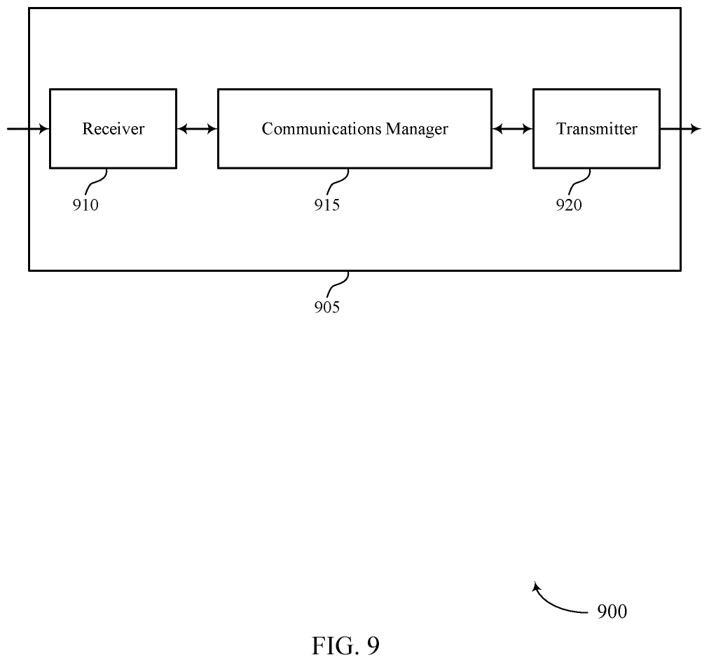

FIG. 9 shows a block diagram 900 of a device 905 that supports sharing system information among multiple cells in accordance with aspects of the present disclosure. The device 905 may be an example of aspects of a base station 105 as described herein. The device 905 may include a receiver 910, a communications manager 915, and a transmitter 920. The device 905 may also include a processor. Each of these components may be in communication with one another (e.g., via one or more buses).

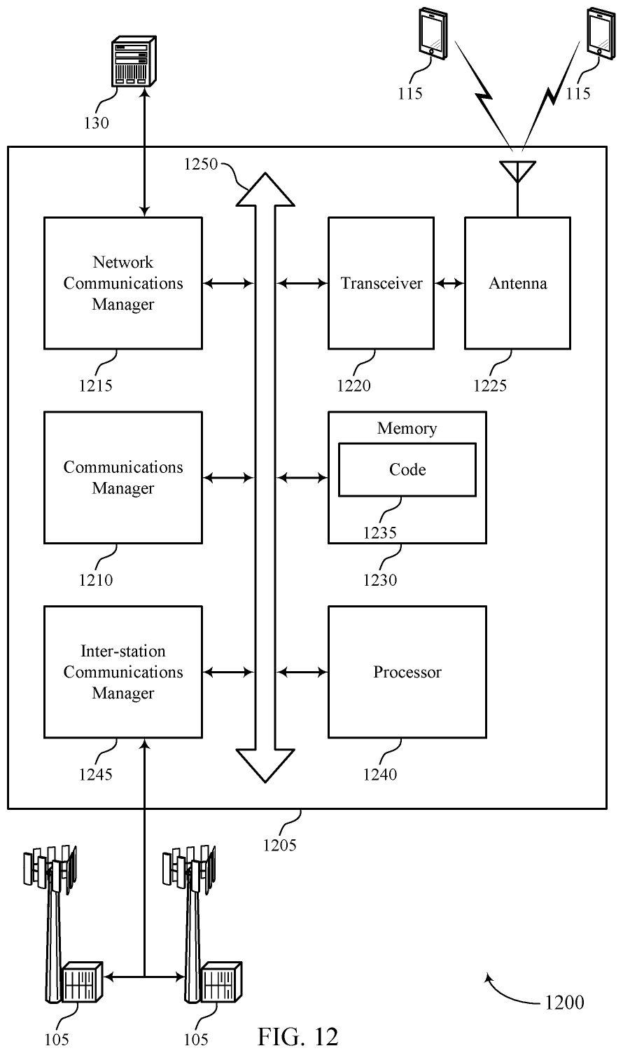

The receiver 910 may receive information such as packets, user data, or control information associated with various information channels (e.g., control channels, data channels, and information related to sharing system information among multiple cells, etc.). Information may be passed on to other components of the device 905. The receiver 910 may be an example of aspects of the transceiver 1220 described with reference to FIG. 12. The receiver 910 may utilize a single antenna or a set of antennas.

The communications manager 915 may transmit, to a UE, a first set of system information for a first cell of the base station, identify an operation mode indicating that the first set of system information is applicable to communications in a set of cells including the first cell and at least one second cell associated with a second base station, and transmit, to the UE, an indication of the identified operation mode. The communications manager 915 may be an example of aspects of the communications manager 1210 described herein.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a DSP, an application-specific integrated circuit (ASIC), an FPGA or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 920 may transmit signals generated by other components of the device 905. In some examples, the transmitter 920 may be collocated with a receiver 910 in a transceiver module. For example, the transmitter 920 may be an example of aspects of the transceiver 1220 described with reference to FIG. 12. The transmitter 920 may utilize a single antenna or a set of antennas.

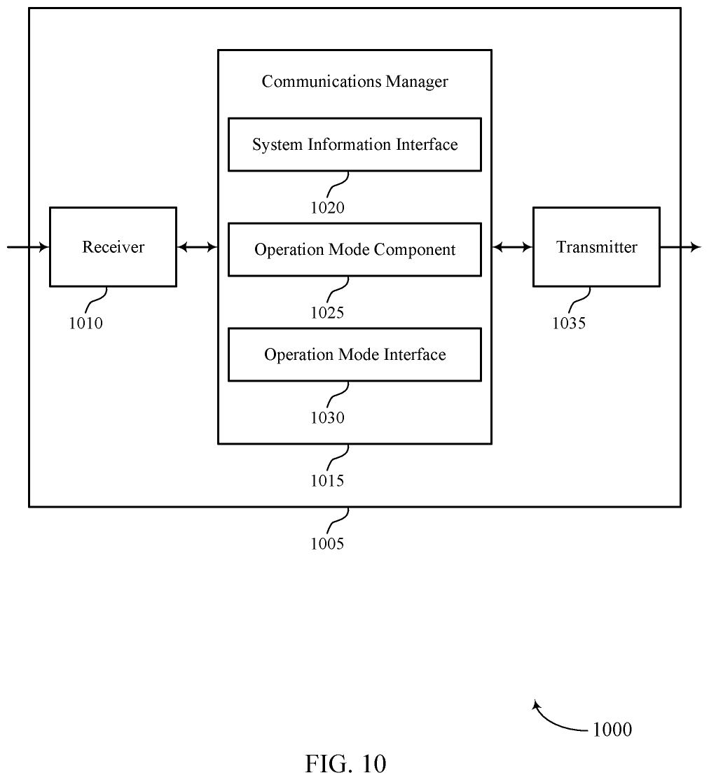

FIG. 10 shows a block diagram 1000 of a device 1005 that supports sharing system information among multiple cells in accordance with aspects of the present disclosure. The device 1005 may be an example of aspects of a device 905, or a base station 105 as described herein. The device 1005 may include a receiver 1010, a communications manager 1015, and a transmitter 1035. The device 1005 may also include a processor. Each of these components may be in communication with one another (e.g., via one or more buses).

The receiver 1010 may receive information such as packets, user data, or control information associated with various information channels (e.g., control channels, data channels, and information related to sharing system information among multiple cells, etc.). Information may be passed on to other components of the device 1005. The receiver 1010 may be an example of aspects of the transceiver 1220 described with reference to FIG. 12. The receiver 1010 may utilize a single antenna or a set of antennas.

The communications manager 1015 may be an example of aspects of the communications manager 915 as described herein. The communications manager 1015 may include a system information interface 1020, an operation mode component 1025, and an operation mode interface 1030. The communications manager 1015 may be an example of aspects of the communications manager 1210 described herein. The system information interface 1020 may transmit, to a UE, a first set of system information for a first cell of the base station.

The operation mode component 1025 may identify an operation mode indicating that the first set of system information is applicable to communications in a set of cells including the first cell and at least one second cell associated with a second base station. The operation mode interface 1030 may transmit, to the UE, an indication of the identified operation mode.

The transmitter 1035 may transmit signals generated by other components of the device 1005. In some examples, the transmitter 1035 may be collocated with a receiver 1010 in a transceiver module. For example, the transmitter 1035 may be an example of aspects of the transceiver 1220 described with reference to FIG. 12. The transmitter 1035 may utilize a single antenna or a set of antennas.

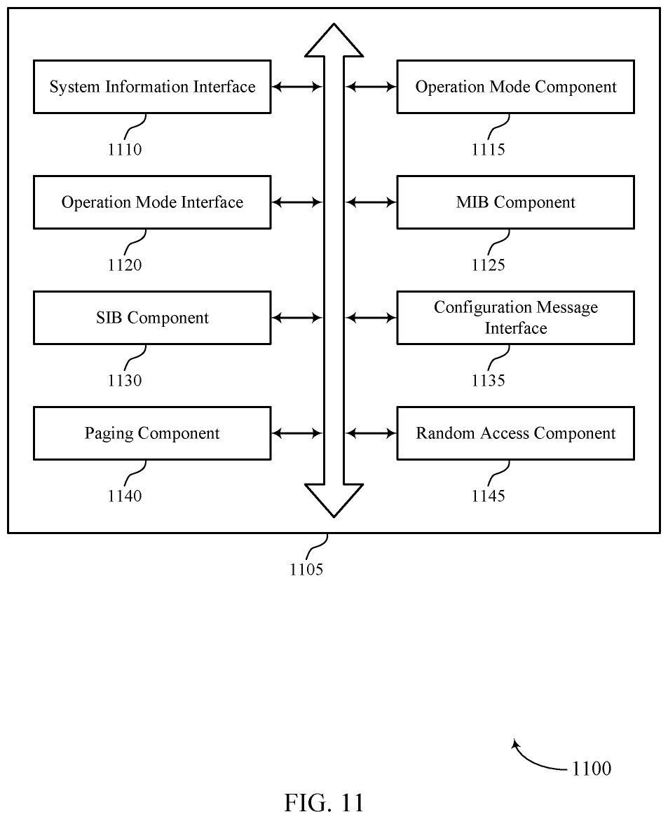

FIG. 11 shows a block diagram 1100 of a communications manager 1105 that supports sharing system information among multiple cells in accordance with aspects of the present disclosure. The communications manager 1105 may be an example of aspects of a communications manager 915, a communications manager 1015, or a communications manager 1210 described herein. The communications manager 1105 may include a system information interface 1110, an operation mode component 1115, an operation mode interface 1120, a MIB component 1125, a SIB component 1130, a configuration message interface 1135, a paging component 1140, and a random access component 1145. Each of these modules may communicate, directly or indirectly, with one another (e.g., via one or more buses).

The system information interface 1110 may transmit, to a UE, a first set of system information for a first cell of the base station.

In some examples, the system information interface 1110 may transmit, to the UE, a second set of system information that is applicable to the set of cells based on the UE being in the operation mode. In some cases, the first set of system information is transmitted in a master information block. In some cases, the first set of system information is transmitted in a system information block.

The operation mode component 1115 may identify an operation mode indicating that the first set of system information is applicable to communications in a set of cells including the first cell and at least one second cell associated with a second base station.

In some cases, the configuration message indicates the set of cells. In some cases, the master information block is shared between the set of cells based on a frequency range associated with the set of cells.

In some cases, the frequency range corresponds to a first frequency range usable by the UE and having frequencies lower than a second frequency range usable by the UE, where the master information block is not shared between cells associated with the second frequency range.

The operation mode interface 1120 may transmit, to the UE, an indication of the identified operation mode.

The MIB component 1125 may identify the first set of system information in a master information block. In some cases, the master information block includes an indication of a subcarrier spacing, a subcarrier offset, a demodulation reference signal position, a system information block location, a cell barred state, an intra-frequency selection state, or a combination thereof, and where one or more of the subcarrier spacing, the subcarrier offset, the demodulation reference signal position, the system information block location, the cell barred state, or the intra-frequency selection state are applicable to the communications in the set of cells.

The SIB component 1130 may identify the first set of system information in a system information block. In some cases, the system information block includes an indication of cell selection information, cell access information, connection establishment information, system information scheduling information, serving cell configuration information, emergency support information, timer information, barring information, extension information, or a combination thereof, and where one or more of the cell selection information, the cell access information, the connection establishment information, the system information scheduling information, the serving cell configuration information, the emergency support information, the timer information, the barring information, or the extension information are applicable to the communications in the set of cells.

The configuration message interface 1135 may transmit a configuration message including the indication of the operation mode. In some examples, the configuration message interface 1135 may transmit the configuration message in a radio resource control message, a medium access control message, a physical downlink shared channel, or in a system information block. In some cases, the configuration message indicates whether a master information block of the first set of system information is shared between the set of cells.

In some cases, the configuration message indicates whether one or more system information blocks of the first set of system information is shared between the set of cells. In some cases, the configuration message includes a physical cell identifier corresponding to each cell of the set of cells. In some cases, the configuration message includes a table identifying the set of cells.

In some cases, the configuration message indicates that the first set of system information is shared between the set of cells based on an area code being shared between the set of cells. In some cases, the area code includes a routing area code or a tracking area code.

The paging component 1140 may transmit, to the UE, a paging signal when the UE is in an inactive state or an idle state. The random access component 1145 may receive from the UE, a random access request, where the second set of system information is transmitted to the UE in response to receiving the random access request.

FIG. 12 shows a diagram of a system 1200 including a device 1205 that supports sharing system information among multiple cells in accordance with aspects of the present disclosure. The device 1205 may be an example of or include the components of device 905, device 1005, or a base station 105 as described herein. The device 1205 may include components for bi-directional voice and data communications including components for transmitting and receiving communications, including a communications manager 1210, a network communications manager 1215, a transceiver 1220, an antenna 1225, memory 1230, a processor 1240, and an inter-station communications manager 1245. These components may be in electronic communication via one or more buses (e.g., bus 1250).

The communications manager 1210 may transmit, to a UE, a first set of system information for a first cell of the base station, identify an operation mode indicating that the first set of system information is applicable to communications in a set of cells including the first cell and at least one second cell associated with a second base station, and transmit, to the UE, an indication of the identified operation mode.

The network communications manager 1215 may manage communications with the core network (e.g., via one or more wired backhaul links). For example, the network communications manager 1215 may manage the transfer of data communications for client devices, such as one or more UEs 115.

The transceiver 1220 may communicate bi-directionally, via one or more antennas, wired, or wireless links as described above. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas.

In some cases, the wireless device may include a single antenna 1225. However, in some cases the device may have more than one antenna 1225, which may be capable of concurrently transmitting or receiving multiple wireless transmissions.

The memory 1230 may include RAM, ROM, or a combination thereof. The memory 1230 may store computer-readable code 1235 including instructions that, when executed by a processor (e.g., the processor 1240) cause the device to perform various functions described herein. In some cases, the memory 1230 may contain, among other things, a BIOS which may control basic hardware or software operation such as the interaction with peripheral components or devices.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some cases, a memory controller may be integrated into processor 1240. The processor 1240 may be configured to execute computer-readable instructions stored in a memory (e.g., the memory 1230) to cause the device 1205 to perform various functions (e.g., functions or tasks supporting sharing system information among multiple cells).

The inter-station communications manager 1245 may manage communications with other base station 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communication network technology to provide communication between base stations 105.

The code 1235 may include instructions to implement aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

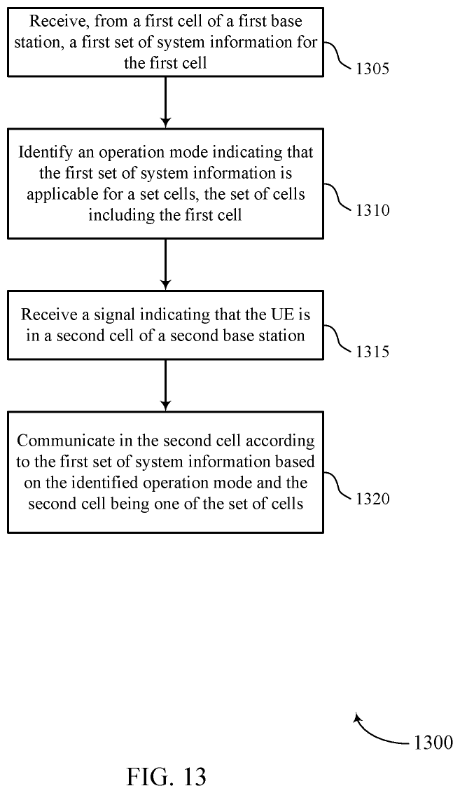

FIG. 13 shows a flowchart illustrating a method 1300 that supports sharing system information among multiple cells in accordance with aspects of the present disclosure. The operations of method 1300 may be implemented by a UE 115 or its components as described herein. For example, the operations of method 1300 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1305, the UE may receive, from a first cell of a first base station, a first set of system information for the first cell. The operations of 1305 may be performed according to the methods described herein. In some examples, aspects of the operations of 1305 may be performed by a system information interface as described with reference to FIGS. 5 through 8.

At 1310, the UE may identify an operation mode indicating that the first set of system information is applicable for a set cells, the set of cells including the first cell. The operations of 1310 may be performed according to the methods described herein. In some examples, aspects of the operations of 1310 may be performed by an operation mode component as described with reference to FIGS. 5 through 8.

At 1315, the UE may receive a signal indicating that the UE is in a second cell of a second base station. The operations of 1315 may be performed according to the methods described herein. In some examples, aspects of the operations of 1315 may be performed by a cell indication component as described with reference to FIGS. 5 through 8.

At 1320, the UE may communicate in the second cell according to the first set of system information based on the identified operation mode and the second cell being one of the set of cells. The operations of 1320 may be performed according to the methods described herein. In some examples, aspects of the operations of 1320 may be performed by a communication interface as described with reference to FIGS. 5 through 8.

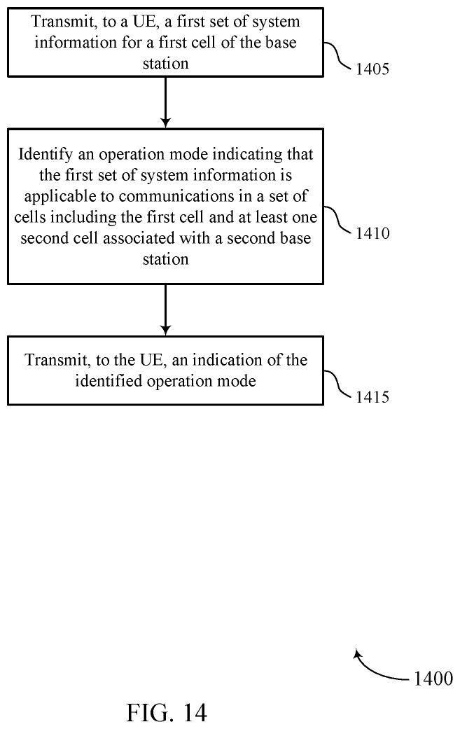

FIG. 14 shows a flowchart illustrating a method 1400 that supports sharing system information among multiple cells in accordance with aspects of the present disclosure. The operations of method 1400 may be implemented by a base station 105 or its components as described herein. For example, the operations of method 1400 may be performed by a communications manager as described with reference to FIGS. 9 through 12. In some examples, a base station may execute a set of instructions to control the functional elements of the base station to perform the functions described below. Additionally or alternatively, a base station may perform aspects of the functions described below using special-purpose hardware.

At 1405, the base station may transmit, to a UE, a first set of system information for a first cell of the base station. The operations of 1405 may be performed according to the methods described herein. In some examples, aspects of the operations of 1405 may be performed by a system information interface as described with reference to FIGS. 9 through 12.

At 1410, the base station may identify an operation mode indicating that the first set of system information is applicable to communications in a set of cells including the first cell and at least one second cell associated with a second base station. The operations of 1410 may be performed according to the methods described herein. In some examples, aspects of the operations of 1410 may be performed by an operation mode component as described with reference to FIGS. 9 through 12.

At 1415, the base station may transmit, to the UE, an indication of the identified operation mode. The operations of 1415 may be performed according to the methods described herein. In some examples, aspects of the operations of 1415 may be performed by an operation mode interface as described with reference to FIGS. 9 through 12.

The following provides an overview of aspects of the present disclosure:

Aspect 1: A method for wireless communications at a UE, comprising: receiving, from a first cell of a first base station, a first set of system information for the first cell; identifying an operation mode indicating that the first set of system information is applicable for a plurality cells, the plurality of cells including the first cell; receiving a signal indicating that the UE is in a second cell of a second base station; and communicating in the second cell according to the first set of system information based at least in part on the identified operation mode and the second cell being one of the plurality of cells.

Aspect 2: The method of aspect 1, wherein the first set of system information is received in a master information block.

Aspect 3: The method of aspect 2, wherein the master information block comprises an indication of a subcarrier spacing, a subcarrier offset, a demodulation reference signal position, a system information block location, a cell barred state, an intra-frequency selection state, or a combination thereof, and communicating in the second cell according to the first set of system information comprises applying, to the second cell, one or more of the subcarrier spacing, the subcarrier offset, the demodulation reference signal position, the system information block location, the cell barred state, or the intra-frequency selection state.

Aspect 4: The method of any of aspects 1 through 3, wherein the first set of system information is received in a system information block.

Aspect 5: The method of aspect 4, wherein the system information block comprises an indication of cell selection information, cell access information, connection establishment information, system information scheduling information, serving cell configuration information, emergency support information, timer information, barring information, extension information, or a combination thereof, and communicating in the second cell according to the first set of system information comprises applying, to the second cell, one or more of the cell selection information, the cell access information, the connection establishment information, the system information scheduling information, the serving cell configuration information, the emergency support information, the timer information, the barring information, or the extension information.

Aspect 6: The method of any of aspects 1 through 5, further comprising: receiving, from the first base station, a configuration message indicating the operation mode, wherein the operation mode is identified based at least in part on the received configuration message.

Aspect 7: The method of aspect 6, further comprising: identifying the plurality of cells based at least in part on the configuration message.

Aspect 8: The method of any of aspects 6 through 7, wherein receiving the configuration message comprises: identifying the configuration message in a radio resource control message, a medium access control message, a physical downlink shared channel, or in a system information block.

Aspect 9: The method of any of aspects 6 through 8, further comprising: determining whether a master information block of the first set of system information is shared between the plurality of cells based at least in part on the configuration message.

Aspect 10: The method of aspect 9, wherein the master information block is shared between the plurality of cells based at least in part on a frequency range associated with the plurality of cells.

Aspect 11: The method of aspect 10, wherein the frequency range corresponds to a first frequency range usable by the UE and having frequencies lower than a second frequency range usable by the UE, the master information block is not shared between cells associated with the second frequency range.

Aspect 12: The method of any of aspects 6 through 9, further comprising: determining whether one or more system information blocks of the first set of system information is shared between the plurality of cells based at least in part on the configuration message.

Aspect 13: The method of any of aspects 6 through 12, wherein the configuration message includes a physical cell identifier corresponding to each cell of the plurality of cells.

Aspect 14: The method of any of aspects 6 through 13, wherein the configuration message comprises a table identifying the plurality of cells.

Aspect 15: The method of any of aspects 1 through 14, further comprising: identifying an area code in the signal indicating that the UE is in the second cell; and determining that the second cell is one of the plurality of cells based at least in part on the area code included in the first set of system information matching the area code included in the signal indicating that the UE is in the second cell.

Aspect 16: The method of aspect 15, wherein the area code comprises a routing area code or a tracking area code.

Aspect 17: The method of any of aspects 15 through 16, further comprising: receiving a configuration message identifying that the first set of system information is shared between the plurality of cells based at least in part on the area code being shared between the plurality of cells.

Aspect 18: The method of any of aspects 1 through 17, further comprising: identifying a cell identifier in the signal indicating that the UE is in the second cell; and determining that the second cell is one of the plurality of cells based at least in part on the cell identifier.

Aspect 19: The method of any of aspects 1 through 18, further comprising: receiving, from one of the first base station and the second base station, a second set of system information that is applicable to the plurality of cells based at least in part on the UE being in the operation mode.

Aspect 20: The method of any of aspects 1 through 19, further comprising: receiving, from one of the first base station and the second base station, a paging signal when the UE is in an inactive or idle state; and transmitting, to the one of the first base station and the second base station, a random access request, wherein the second set of system information is received in response to the random access request.

Aspect 21: The method of any of aspects 1 through 20, wherein communicating in the second cell comprises: communicating with the second base station without decoding at least a portion of system information received in the signal indicating that the UE is in the second cell.

Aspect 22: The method of any of aspects 1 through 21, wherein communicating in the second cell comprises: identifying that the UE is in an inactive state or an idle state; and performing a radio resource management procedure, a cell reselection procedure, or both, in the second cell using the first set of system information based at least in part on identifying that the UE is in the inactive state or the idle state.

Aspect 23: The method of any of aspects 1 through 22, wherein receiving the signal indicating that the UE is in the second cell comprises: identifying a synchronization signal block in a signal broadcast by the second base station, wherein the synchronization signal block comprises information identifying the second cell.

Aspect 24: A method for wireless communications at a base station, comprising: transmitting, to a UE, a first set of system information for a first cell of the base station; identifying an operation mode indicating that the first set of system information is applicable to communications in a plurality of cells including the first cell and at least one second cell associated with a second base station; and transmitting, to the UE, an indication of the identified operation mode.

Aspect 25: The method of aspect 24, wherein the first set of system information is transmitted in a master information block.

Aspect 26: The method of aspect 25, wherein the master information block comprises an indication of a subcarrier spacing, a subcarrier offset, a demodulation reference signal position, a system information block location, a cell barred state, an intra-frequency selection state, or a combination thereof, and one or more of the subcarrier spacing, the subcarrier offset, the demodulation reference signal position, the system information block location, the cell barred state, or the intra-frequency selection state are applicable to the communications in the plurality of cells.

Aspect 27: The method of any of aspects 24 through 26, wherein the first set of system information is transmitted in a system information block.

Aspect 28: The method of aspect 27, wherein the system information block comprises an indication of cell selection information, cell access information, connection establishment information, system information scheduling information, serving cell configuration information, emergency support information, timer information, barring information, extension information, or a combination thereof, and one or more of the cell selection information, the cell access information, the connection establishment information, the system information scheduling information, the serving cell configuration information, the emergency support information, the timer information, the barring information, or the extension information are applicable to the communications in the plurality of cells.

Aspect 29: The method of any of aspects 24 through 28, wherein transmitting the indication of the operation mode comprises: transmitting a configuration message including the indication of the operation mode.

Aspect 30: The method of aspect 29, wherein the configuration message indicates the plurality of cells.

Aspect 31: The method of any of aspects 29 through 30, wherein transmitting the configuration message comprises: transmitting the configuration message in a radio resource control message, a medium access control message, a physical downlink shared channel, or in a system information block.

Aspect 32: The method of any of aspects 29 through 31, wherein the configuration message indicates whether a master information block of the first set of system information is shared between the plurality of cells.

Aspect 33: The method of aspect 32, wherein the master information block is shared between the plurality of cells based at least in part on a frequency range associated with the plurality of cells.

Aspect 34: The method of aspect 33, wherein the frequency range corresponds to a first frequency range usable by the UE and having frequencies lower than a second frequency range usable by the UE, the master information block is not shared between cells associated with the second frequency range.

Aspect 35: The method of any of aspects 29 through 34, wherein the configuration message indicates whether one or more system information blocks of the first set of system information is shared between the plurality of cells.

Aspect 36: The method of any of aspects 29 through 35, wherein the configuration message includes a physical cell identifier corresponding to each cell of the plurality of cells.

Aspect 37: The method of any of aspects 29 through 36, wherein the configuration message comprises a table identifying the plurality of cells.

Aspect 38: The method of any of aspects 29 through 37, wherein the configuration message indicates that the first set of system information is shared between the plurality of cells based at least in part on an area code being shared between the plurality of cells.

Aspect 39: The method of aspect 38, wherein the area code comprises a routing area code or a tracking area code.

Aspect 40: The method of any of aspects 24 through 39, further comprising: transmitting, to the UE, a second set of system information that is applicable to the plurality of cells based at least in part on the UE being in the operation mode.

Aspect 41: The method of aspect 40, further comprising: transmitting, to the UE, a paging signal when the UE is in an inactive state or an idle state; and receiving from the UE, a random access request, wherein the second set of system information is transmitted to the UE in response to receiving the random access request.

Aspect 42: An apparatus for wireless communications at a UE, comprising a processor; memory coupled with the processor; and instructions stored in the memory and executable by the processor to cause the apparatus to perform a method of any of aspects 1 through 23.

Aspect 43: An apparatus for wireless communications at a UE, comprising at least one means for performing a method of any of aspects 1 through 23.

Aspect 44: A non-transitory computer-readable medium storing code for wireless communications at a UE, the code comprising instructions executable by a processor to perform a method of any of aspects 1 through 23.

Aspect 45: An apparatus for wireless communications at a base station, comprising a processor; memory coupled with the processor; and instructions stored in the memory and executable by the processor to cause the apparatus to perform a method of any of aspects 24 through 41.

Aspect 46: An apparatus for wireless communications at a base station, comprising at least one means for performing a method of any of aspects 24 through 41.

Aspect 47: A non-transitory computer-readable medium storing code for wireless communications at a base station, the code comprising instructions executable by a processor to perform a method of any of aspects 24 through 41.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a user equipment (UE), comprising:
receiving, from a first cell of a first base station, a first set of system information for the first cell;
identifying an operation mode indicating that the first set of system information is applicable for a plurality cells, the plurality of cells including the first cell;
receiving a signal indicating that the UE is in a second cell of a second base station; and
communicating in the second cell according to the first set of system information based at least in part on the identified operation mode and the second cell being one of the plurality of cells.

2. The method of claim 1, wherein the first set of system information is received in a master information block.

3. The method of claim 2, wherein the master information block comprises an indication of a subcarrier spacing, a subcarrier offset, a demodulation reference signal position, a system information block location, a cell barred state, an intra-frequency selection state, or a combination thereof, and wherein communicating in the second cell according to the first set of system information comprises applying, to the second cell, one or more of the subcarrier spacing, the subcarrier offset, the demodulation reference signal position, the system information block location, the cell barred state, or the intra-frequency selection state.

4. The method of claim 1, wherein the first set of system information is received in a system information block.

5. The method of claim 4, wherein the system information block comprises an indication of cell selection information, cell access information, connection establishment information, system information scheduling information, serving cell configuration information, emergency support information, timer information, barring information, extension information, or a combination thereof, and wherein communicating in the second cell according to the first set of system information comprises applying, to the second cell, one or more of the cell selection information, the cell access information, the connection establishment information, the system information scheduling information, the serving cell configuration information, the emergency support information, the timer information, the barring information, or the extension information.

6. The method of claim 1, further comprising:
receiving, from the first base station, a configuration message indicating the operation mode, wherein the operation mode is identified based at least in part on the received configuration message.

7. The method of claim 6, further comprising:
identifying the plurality of cells based at least in part on the configuration message.

8. The method of claim 6, wherein receiving the configuration message comprises:
identifying the configuration message in a radio resource control message, a medium access control message, a physical downlink shared channel, or in a system information block.

9. The method of claim 6, further comprising:
determining whether a master information block or one or more system information blocks of the first set of system information is shared between the plurality of cells based at least in part on the configuration message.

10. The method of claim 9, wherein the master information block is shared between the plurality of cells based at least in part on a frequency range associated with the plurality of cells.

11. The method of claim 10, wherein the frequency range corresponds to a first frequency range usable by the UE and having frequencies lower than a second frequency range usable by the UE, wherein the master information block is not shared between cells associated with the second frequency range.

12. The method of claim 6, wherein the configuration message includes a physical cell identifier corresponding to each cell of the plurality of cells or a table identifying the plurality of cells.

13. The method of claim 1, further comprising:
identifying an area code in the signal indicating that the UE is in the second cell; and
determining that the second cell is one of the plurality of cells based at least in part on the area code included in the first set of system information matching the area code included in the signal indicating that the UE is in the second cell; and
receiving a configuration message identifying that the first set of system information is shared between the plurality of cells based at least in part on the area code being shared between the plurality of cells.

14. The method of claim 1, further comprising:
receiving, from one of the first base station and the second base station, a second set of system information that is applicable to the plurality of cells based at least in part on the UE being in the operation mode.

15. The method of claim 14, further comprising:
receiving, from one of the first base station and the second base station, a paging signal when the UE is in an inactive or idle state; and
transmitting, to the one of the first base station and the second base station, a random access request, wherein the second set of system information is received in response to the random access request.

16. The method of claim 1, wherein communicating in the second cell comprises:
communicating with the second base station without decoding at least a portion of system information received in the signal indicating that the UE is in the second cell.

17. The method of claim 1, wherein communicating in the second cell comprises:
identifying that the UE is in an inactive state or an idle state; and
performing a radio resource management procedure, a cell reselection procedure, or both, in the second cell using the first set of system information based at least in part on identifying that the UE is in the inactive state or the idle state.

18. A method for wireless communications at a base station, comprising:
transmitting, to a user equipment (UE), a first set of system information for a first cell of the base station;
identifying an operation mode indicating that the first set of system information is applicable to communications in a plurality of cells including the first cell and at least one second cell associated with a second base station; and
transmitting, to the UE, an indication of the identified operation mode.

19. The method of claim 18, wherein the first set of system information is transmitted in a master information block.

20. The method of claim 19, wherein the master information block comprises an indication of a subcarrier spacing, a subcarrier offset, a demodulation reference signal position, a system information block location, a cell barred state, an intra-frequency selection state, or a combination thereof, and wherein one or more of the subcarrier spacing, the subcarrier offset, the demodulation reference signal position, the system information block location, the cell barred state, or the intra-frequency selection state are applicable to the communications in the plurality of cells.

21. The method of claim 18, wherein the first set of system information is transmitted in a system information block.

22. The method of claim 21, wherein the system information block comprises an indication of cell selection information, cell access information, connection establishment information, system information scheduling information, serving cell configuration information, emergency support information, timer information, barring information, extension information, or a combination thereof, and wherein one or more of the cell selection information, the cell access information, the connection establishment information, the system information scheduling information, the serving cell configuration information, the emergency support information, the timer information, the barring information, or the extension information are applicable to the communications in the plurality of cells.

23. The method of claim 18, wherein transmitting the indication of the operation mode comprises:
transmitting a configuration message including the indication of the operation mode.

24. The method of claim 23, wherein the configuration message indicates the plurality of cells.

25. The method of claim 23, wherein transmitting the configuration message comprises:
transmitting the configuration message in a radio resource control message, a medium access control message, a physical downlink shared channel, or in a system information block.

26. The method of claim 23, wherein the configuration message indicates whether a master information block or one or more system information blocks of the first set of system information is shared between the plurality of cells.

27. The method of claim 23, wherein the configuration message includes a physical cell identifier corresponding to each cell of the plurality of cells or a table identifying the plurality of cells.

28. The method of claim 23, wherein the configuration message indicates that the first set of system information is shared between the plurality of cells based at least in part on an area code being shared between the plurality of cells.

29. An apparatus for wireless communications at a user equipment (UE), comprising:
a processor,
memory coupled with the processor; and
instructions stored in the memory and executable by the processor to cause the apparatus to:
receive, from a first cell of a first base station, a first set of system information for the first cell;
identify an operation mode indicating that the first set of system information is applicable for a plurality cells, the plurality of cells including the first cell;
receive a signal indicating that the UE is in a second cell of a second base station; and
communicate in the second cell according to the first set of system information based at least in part on the identified operation mode and the second cell being one of the plurality of cells.

30. An apparatus for wireless communications at a base station, comprising:
a processor,
memory coupled with the processor; and
instructions stored in the memory and executable by the processor to cause the apparatus to:
transmit, to a user equipment (UE), a first set of system information for a first cell of the base station;
identify an operation mode indicating that the first set of system information is applicable to communications in a plurality of cells including the first cell and at least one second cell associated with a second base station; and
transmit, to the UE, an indication of the identified operation mode.
